(19) United States
(12) Patent Application Publication
(10) Pub. No.: US 2015/0188845 A1
(43) Pub. Date: Jul. 2, 2015

(54) MITIGATING BANDWIDTH DEGRADATION IN A SWITCHING DEVICE

(71) Applicant: Broadcom Corporation, Irvine, CA (US)

(72) Inventors: Brad Matthews, San Jose, CA (US); Puneet Agarwal, Cupertino, CA (US); Bruce Kwan, Sunnyvale, CA (US)

(73) Assignee: Broadcom Corporation, Irvine, CA (US)

(21) Appl. No.: 14/231,422

(22) Filed: Mar. 31, 2014

Related U.S. Application Data
(60) Provisional application No. 61/923,101, filed on Jan. 2, 2014.

(51) Int. Cl. H04L 12/927; H04L 12/911

(52) U.S. Cl. CPC H04L 47/805; H04L 47/826

(57) ABSTRACT

A switching device is operable to mitigate bandwidth degradation while it is oversubscribed. Due to a latency involved with notifying a scheduler that a queue has transitioned from an active state to an empty state, the scheduler may inadvertently schedule an empty queue for processing, which may result in a degradation of bandwidth of the switching device. To avoid such degradation, the switching device may be configured to control the flow of data provided from the queue to the scheduler so that the data is provided to the scheduler as a burst transaction. For example, the switching device may be configured to delay the provision of certain indicators provided by a queue in order to defer the notification to the scheduler of when the queue receives and stores data. This may enable the queue to store more data, which can be provided to the scheduler as a burst transaction.

### CROSS REFERENCE TO RELATED APPLICATION

This application claims priority to U.S. Provisional Application Ser. No. 61/923,101, filed Jan. 2, 2014, the entirety of which is incorporated by reference herein.

### BACKGROUND

1. Technical Field

The subject matter described herein relates to switching devices. In particular, the subject matter described herein relates to mitigating bandwidth degradation in switching devices.

2. Description of Related Art

Entities that develop and/or maintain data centers face increasing bandwidth demands from customers. In particular, the bandwidth requirement for network switches is increasing dramatically due to the growth in data center size, the shift to higher bandwidth link standards, such as 10 Gb, 40 Gb, and 100 Gb Ethernet standards, and the shift to cloud computing. As the number of consumers and services offered increase, the performance of these networks can degrade, in part, from link and pathway congestion. During information transport, link and pathway congestion customarily results in transmitted units of data becoming unevenly distributed over time, excessively queued, and/or discarded, thereby degrading the quality of network communications. Network devices, such as routers and switches, play a key role in the rapid and successful transport of such information. One approach to improving quality network communications is to deploy routers and switches with more processing power and capacity, an approach that can be cost prohibitive.

### BRIEF SUMMARY

Methods, systems, and apparatuses are described for mitigating bandwidth degradation of a switching device, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 is a block diagram of a switching device in accordance with an embodiment described herein.

FIG. 2 is a block diagram of selection delay logic coupled to queue and scheduling logic in accordance with an embodiment described herein.

FIG. 3 is a flowchart providing example steps for mitigating bandwidth degradation in accordance with an embodiment described herein.

FIGS. 4 and 5 are flowcharts providing example steps for delaying provision(s) of state indicator(s) in accordance with embodiments described herein.

FIGS. 6 and 7 are flowcharts providing example steps for discontinuing the delaying of provision(s) of state indicator(s) in accordance with embodiments described herein.

FIG. 8 is a block diagram of an example computer system in which embodiments may be implemented.

Embodiments will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Example embodiments relate to a switching device that is operable to mitigate bandwidth degradation during an oversubscribed state of the switching device. An oversubscribed state of a switching device is a state in which a supported input/output (I/O) bandwidth of the switching device exceeds a throughput provided by the switching device for the worst case packet size. The supported I/O bandwidth of the switching device is a sum of the peak operating rates for the ports in the switching device. The worst case packet size is the packet size for which the throughput of the switching device is lowest, as compared to other packet sizes.

In some example embodiments, a switching device includes queue(s), a plurality of ports, and a scheduler. Any one or more of the queue(s) may be coupled to any one or more ports that are included in the plurality of ports. During an oversubscribed state, packets having relatively small packet sizes that are received via the plurality of ports may cause the queue(s), which store data received by the ports, to transition from an active state to an empty state relatively frequently. An active state of a queue is a state in which the queue contains data. An empty state of a queue is a state in which the queue does not contain data. Due to a latency involved with a queue notifying the scheduler that the queue has transitioned from an active state into an empty state, the scheduler may inadvertently schedule an empty queue for processing, which may result in a degradation of bandwidth of the switching device. To avoid such degradation, the switching device may be configured to control the flow of data provided from the queue to the scheduler such that the data is provided to the scheduler as a burst transaction. For example, the switching device may be configured to delay the provision of certain indicator(s) provided by the queue in order to defer the notification of the scheduler that the queue has data available for the scheduler to schedule for transmission. By doing so, the queue can continue to receive and store additional data. By the time the scheduler receives the indicator(s), the queue may be more likely to have enough data so that the data can be provided to the scheduler as a burst transaction. Accordingly, the number of transitions from the active state to the empty state for any given queue may be reduced, and the bandwidth may not be unnecessarily degraded.

In accordance with embodiments, the scheduler of a switching device performs scheduling operations to provide exclusive access to processing resources for a queue. Each access event may be referred to as a slot. When the input demand exceeds the capacity of the packet processing pipeline, the switching device is said to be in an oversubscribed state. This may occur, for example, when a majority of the ports receive relatively smaller packet sizes at a high data rate. During this time period, in order to achieve maximum throughput, it is important that as many slots as possible are used.

Slots maybe classified as being of two types: guaranteed (i.e., a slot that is provided to ports that are guaranteed to achieve maximum throughput (i.e., the ports operate at line rate)) and shared (i.e., a slot that is provided to ports that are not guaranteed to achieve maximum throughput). Ports utilizing shared slots are given best-effort access to bandwidth. Ports may be assigned to either guaranteed slots or shared slots. Under most scenarios, a given port will receive sufficient bandwidth to transmit/receive at a peak operating rate with no bandwidth loss. During periods when there is insufficient packet processing bandwidth for certain traffic demand, ports that are assigned to use shared slots may be impacted.

An example method is described. The method includes determining a first number that indicates a total number of shared slots in a first plurality of slots that correspond to a first time period that begins at a first time instance. A shared slot is a slot that is provided to ports that are not guaranteed to achieve maximum throughput. A second number that indicates a total number of null shared slots in the first plurality of slots is determined. A null shared slot is a shared slot during which no queue is selected (independent of whether or not the device is in an oversubscribed state). The first number and the second number are compared to provide a third number. The third number is compared to a threshold to determine whether provision(s) of respective indicator(s) are to be delayed during a second time period that corresponds to a second plurality of slots. The second time period begins at a second time instance that occurs after the first time instance. Each of the indicator(s) specifies that data is available to be scheduled for processing.

A switching device is also described. The switching device includes queues, a scheduler coupled to the queues, and selective delay logic coupled to the queues and the scheduler. The selective delay logic is configured to determine a first number of slots that are included in a first plurality of slots. The first plurality of slots correspond to a first time period that begins at a first time instance. The selective delay logic is further configured to determine a second number of slots that are included in the first plurality of slots for which the scheduler does not perform a selection of at least one of the ports while the switching device is in the oversubscribed state. The selective delay logic is further configured to compare the first number and the second number to provide a third number. The selective delay logic is further configured to compare the third number to a threshold to determine whether provision(s) of respective indicator(s) by at least one of the queues for receipt by the scheduler are to be delayed during a second time period to which a second plurality of slots corresponds. The second time period begins at a second time instance that occurs after the first time instance. Each of the indicator(s) specifies that data stored in one or more of the queues is available to be provided to the scheduler.

A computer readable storage medium having computer program instructions embodied in said computer readable storage medium for enabling a processor to mitigate bandwidth degradation for a switching device is also described. The computer program instructions include instructions executable to perform operations. The operations include determining a first number that indicates a total number of shared slots in a first plurality of slots that correspond to a first time period that begins at a first time instance. The operations further include determining a second number that indicates a total number of null shared slots in the first plurality of slots. The operations further include comparing the first number and the second number to provide a third number. The operations further include comparing the third number to a threshold to determine whether provision(s) of respective indicator(s) are to be delayed during a second time period that corresponds to a second plurality of slots. The second time period begins at a second time instance that occurs after the first time instance. Each of the indicator(s) specifies that data is available to be scheduled for processing.

### II. Example Embodiments

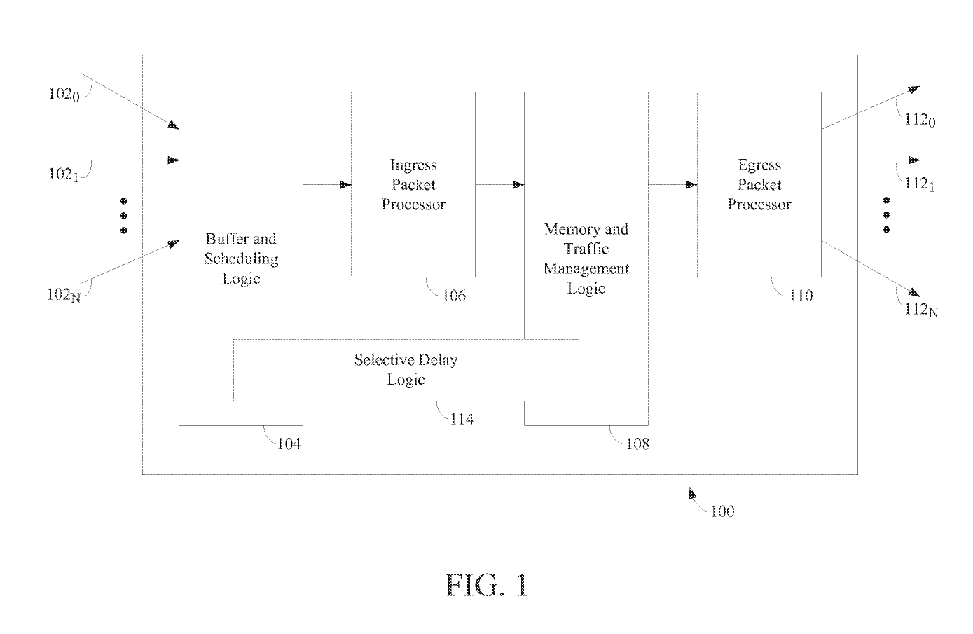

FIG. 1 is block diagram of an example switching device 100 in accordance with an embodiment. In an example embodiment, switching device 100 is a high bandwidth switching device that is operable to receive data (e.g., packets or portions thereof) from one or more remote devices, process the data, and route the data to the same remote device(s) and/or different remote device(s). As shown in FIG. 1, switching device 100 includes a plurality of ingress ports 102₀-102_{N}, buffer and scheduling logic 104, an ingress packet processor 106, memory and traffic management logic 108, an egress packet processor 110, and a plurality of egress ports 112₀-112_{N}.

Each of ingress ports 102₀-102_{N} may be configured to receive portions of packets transmitted by a remote device communicatively coupled (e.g., via a wired or wireless connection) to switching device 100. Buffer and scheduling logic 104 may be configured to buffer the portions that are received at ingress ports 102₀-102_{N}. Buffer and scheduling logic 104 may include a queue for each of ingress ports 102₀-102_{N} to store portions that are received from the respective ingress port. The portions may be assembled into one or more segments (referred to as “cells”). Buffer and scheduling logic 104 may include a scheduler that is configured to schedule the assembled cell(s) for access by ingress packet processor 106.

Ingress packet processor 106 may be configured to process the cell(s), for example, by parsing the content of the cell(s) (e.g., packet headers), performing error checking, performing security checking and decoding, packet classification, etc. Ingress packet processor 106 may also be configured to determine a destination of the cell(s) (e.g., one or more of egress ports 112₀-112_{N} from which the cell(s) may be transmitted to another device that is communicatively coupled to switching device 100). The cell(s) that are processed by ingress packet processor 106 may be stored in a memory, for example, included in memory and traffic management logic 108.

Memory and traffic management logic 108 may be configured to retrieve the processed cell(s) from the memory and store the retrieved cell(s) into queue(s) included in memory and traffic management logic 108. Memory and traffic management logic 108 may further include a scheduler that is configured to schedule the retrieved cell(s) that are stored in the queues for access by egress packet processor 110.

Egress packet processor 110 may be configured to further process the cell(s), for example, by calculating and adding error detection and correction codes, segmenting and/or fragmenting the cell(s) for transmission to another device that is communicatively coupled to switching device 100, etc. After processing the cell(s), egress packet processor 110 may provide the cell(s) among egress port(s) 112₀-112_{N} as determined by ingress packet processor 106. It is noted that while FIG. 1 shows ingress ports 102₀-102_{N} and egress ports 112₀-112_{N} as unidirectional ports, in accordance with some embodiments, switching device 100 may include bidirectional ingress/egress ports.

As further shown in FIG. 1, switching device 100 may also include selective delay logic 114. In accordance with an embodiment, selective delay logic 114 is included in buffer and scheduling logic 104. In accordance with another embodiment, selective delay logic 114 is included in memory and traffic management logic 108. In accordance with yet another embodiment, selective delay logic 114 is included in each of buffer and scheduling logic 104 and memory and traffic management logic 108. In accordance with still another embodiment, selective delay logic 114 is distributed across buffer and scheduling logic 104 and memory and traffic management logic 108.

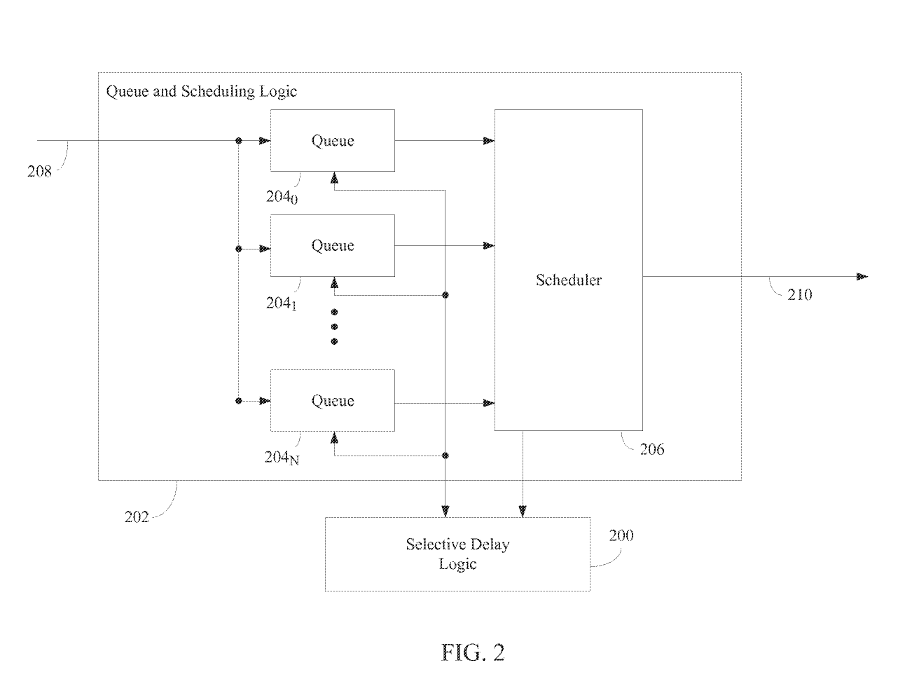

As will be described below with reference to FIG. 2, selective delay logic 114 may be configured to mitigate bandwidth degradation of switching device 100, which is caused, at least in part, by a latency associated with the queue(s) included in buffer and scheduling logic 104 and/or memory and traffic management logic 108 transitioning from an active state to an empty state. For example, selective delay logic 114 may be configured to delay the provision of state indicator(s) that indicate the state(s) of respective queue(s). In accordance with an embodiment in which selective delay logic 114 is included in buffer and scheduling logic 104, selective delay logic 114 is configured to delay the provision of state indicator(s), which indicate the state(s) of respective queue(s) included in buffer and scheduling logic 104, to a scheduler that is included in buffer and scheduling logic 104. In accordance with an embodiment in which selective delay logic 114 is included in memory and traffic management logic 108, selective delay logic 114 is configured to delay the provision of state indicator(s), which indicate the state(s) of respective queue(s) included in memory and traffic management logic 108, to a scheduler that is included in memory and traffic management logic 108.

FIG. 2 is a block diagram of selective delay logic 200 coupled to queue and scheduling logic 202 in accordance with an embodiment. Selective delay logic 200 may be an example of selective delay logic 114 as described above with respect to FIG. 1. Queue and scheduling logic 202 may be included in buffer and scheduling logic 104, in memory and traffic management logic 108, in each of buffer and scheduling logic 104 and memory and traffic management logic 108, or distributed across buffer and scheduling logic 104 and memory and traffic management logic 108. Queue and scheduling logic 202 may include a plurality of queues 204₀-204_{N} and a scheduler 206. Each of queues 204₀-204_{N} may be coupled to a receive path 208. In accordance with an embodiment in which queue and scheduling logic 202 is included in buffer and scheduling logic 104, receive path 208 may comprise of one or more buses coupling ingress ports 102₀-102_{N} (as shown FIG. 1) to queues 204₀-204_{N}. In accordance with such an embodiment, queue 204₀ may be configured to receive and store portions of packets received via ingress port 102₀; queue 204₁ may be configured to receive and store portions of packets received via ingress port 102₁, and so on.

In accordance with an embodiment in which queue and scheduling logic 202 is included in memory and traffic management logic 108, receive path 208 may include one or more buses coupling ingress packet processor 106 to queues 204₀-204_{N}. In accordance with such an embodiment, queue 204₀ may be configured to receive and store portions of packets received via ingress port 102₀ and processed by ingress packet processor 106; queue 204₁ may be configured to receive and store portions of packets received via ingress port 102₁ and processed by ingress packet processor 106, and so on.

Each of queues 204₀-204_{N} may be further configured to provide state indicator(s) to scheduler 206 that indicates whether or not the queue is in an active state or an empty state. A queue may enter an active state upon receiving and storing a cell of a packet. When in an active state, the cell(s) of the packet are available to be provided to scheduler 206. A queue is in an empty state if it does not store any cells of a packet (i.e., the queue is empty). Accordingly, each of queues 204₀-204_{N} is configured to transition from an active state to an empty state when the queue becomes empty after providing the cell(s) stored therein to scheduler 206.

Scheduler 206 may be configured to schedule access for cell(s) stored in queues 204₀-204_{N} to a packet processor. The cell(s) may be provided to the packet processor via transmit path 210. In accordance with an embodiment in which queue and scheduling logic 202 is included in buffer and scheduling logic 104, scheduler 206 may be configured to schedule access by ingress packet processor 106 to cell(s) that are stored in queues 204₀-204_{N}. In accordance with an embodiment in which queue and scheduling logic 202 is included in memory and traffic management logic 108, scheduler 206 may be configured to schedule access by egress packet processor 110 to cell(s) stored in queues 204₀-204_{N}.

Scheduler 206 may be configured to schedule access to a packet processor in a round-robin fashion, where scheduler 206 is configured to access each of queues 204₀-204_{N} for cell(s) stored therein in a sequential order. Scheduler 206 may be configured to access only queue(s) that are in an active state. Thus, scheduler 206 may access a queue if scheduler 206 has received a state indicator from the queue that indicates that the queue is in the active state. Scheduler 206 may bypass a queue when scheduling access to a packet processor if scheduler 206 has received a state indicator from the queue that indicates that the queue is in an empty state.

Scheduler 206 may be configured to operate on a time slot (“slot”) basis. Each slot may be a single clock cycle in which exclusive access is provided to a packet processor for a queue of queues 204₀-204_{N} to transmit a single cell. For example, suppose that four queues are in an active state: Queue A, Queue B, Queue C, and Queue D. In such a case, scheduler 206 would access Queue A in a first slot (“slot 0”), Queue B in a second slot (“slot 1”), Queue C in a third slot (“slot 2”), and Queue D in a fourth slot (“slot 3”).

Switching device 100 may enter into an oversubscribed state in which the supported I/O bandwidth (i.e., the sum of the peak operating rates for all the ports (e.g., ingress ports 102₀-102_{N} and/or egress ports 112₀-112_{N})) exceeds the throughput provided by switching device 100 for the worst case packet size (i.e., a packet size among a plurality of packet sizes at which the bandwidth of switching device 100 is lowest with respect to others of the plurality of packet sizes). An oversubscribed state may occur, for example, when a majority of the ports receive relatively smaller packet sizes at a high data rate. In certain cases when switching device 100 is in an oversubscribed state, for example when the bandwidth is distributed less efficiently (thereby resulting in sub-optimal throughput), packets are dropped more frequently due to a latency associated with propagating the state indicator(s) from queue(s) 204₀-204_{N} to scheduler 206. For example, scheduler 206 may receive a state indicator in each of N slots, where N is an integer. In accordance with this example, N is greater than the number of active queues. In further accordance with this example, scheduler 206 may schedule access to a packet processor for an empty queue, thereby resulting in a loss of bandwidth.

For instance, suppose that the latency associated with propagating the state indicator from a queue to scheduler 206 is ten time slots. Returning to the example above, suppose that at slot 0, Queue A is accessed, transitions to an empty state, and provides a state indicator to scheduler 208 indicating that Queue A is empty. Queues B, C, and D, are then accessed at slots 1, 2, and 3, respectively. At slot 4, instead of bypassing Queue A, scheduler 206 may access Queue A even though it is in an empty state because scheduler 206 has yet to receive the state indicator from Queue A. Scheduler 206 will not receive the state indicator from Queue A until slot 10. Accordingly, scheduler 206 will also access Queue A at slot 8, thereby resulting in a greater loss of bandwidth.

To minimize the bandwidth degradation caused by the latency associated with the active-to-empty transition (i.e., transition from an active state to an empty state), selective delay logic 200 may be configured to reduce the number of active-to-empty transitions for queues 204₀-204_{N} while switching device 100 is in an oversubscribed state. For example, it has been observed that cells that are transmitted as burst transactions (i.e., a group of two or more cells that are transmitted back-to-back) result in fewer active-to-empty transitions over a given number of time slots. The amount of active-to-empty transitions decreases as the length of the burst transaction increases. Accordingly, as will be described below, selective delay logic 200 may be configured to control the flow of cells being provided by queues 204₀-204_{N} to scheduler 206 while switching device 100 is in an oversubscribed state and while the traffic load exceeds its processing ability such that the cells are provided to scheduler 206 as a burst transaction.

Selective delay logic 200 may be configured to determine when the traffic load exceeds its processing ability. For example, selective delay logic 200 may be configured to determine the percentage of slots in which no queue was selected for scheduling over a predetermined sampling period (e.g., an N number of slots, where N is any positive integer). A slot during which no queue is selected may be referred to as a null shared slot. During a null shared slot, scheduler 206 may be capable of selecting at least one of queue 204₀-204_{N}, but does not because each of queues 204₀-204_{N} does not contain any cells (or is ineligible to transmit cells during that slot for other reasons (e.g., traffic shaping). If the percentage of null shared slots does not exceed (e.g., is less than or equal to) a threshold (e.g., a predetermined threshold), then selective delay logic 200 may determine that the traffic load exceeds its processing ability.

In response to such a determination, selective delay logic 200 may delay the provision of state indicator(s) that occur after queue(s) 204₀-204_{N} transition from an active state to an empty state. For example, the provision of a state indicator that indicates that a particular queue is in an active state to scheduler 206 may be delayed. The provision of the state indicator may be delayed by an M number of slots that occur after the particular queue has received and stored cell(s), where M is any positive integer. If the percentage of null shared slots exceeds (e.g., is greater than) the predetermined threshold, then selective delay logic 200 may determine that the throughput is maximized, and the provision of state indicator(s) is not delayed.

The value for M may vary for each queue. In accordance with an embodiment, M, for a particular queue, is based on a data rate at which a port (e.g., any of ingress ports 102₀-102_{N} and/or egress ports 112₀-112_{N}) coupled to the queue operates. For example, queue(s) that are coupled to faster ports may be configured to have a larger value for M than queue(s) that are coupled to slower ports.

By delaying the provision of state indicator(s) that indicate that queue(s) 204₀-204_{N} are active, queue(s) 204₀-204_{N} are enabled to receive and store a plurality of cells (as opposed to a single cell) before providing the state indicator(s) to scheduler 206. In this way, when scheduler 206 selects a particular queue from queues 204₀-204_{N} for scheduling, the cells provided by the selected queue are provided back-to-back as a burst transaction.

To determine the percentage of null shared slots, selective delay logic 200 may divide the number of null shared slots in a plurality of slots by a total number of shared slots in the plurality of slots. A shared slot is a slot that is provided to ports that are not guaranteed to achieve maximum throughput. During a shared slot, scheduler 206 may perform a selection of at least one of queues 204₀-204_{N}. For example, a shared slot may be a slot in which scheduler 206 selects an active queue (i.e., a queue that stores one or more cell(s) that are available to be provided to scheduler 206) from queues 204₀-204_{N} or an empty queue from queues 204₀-204_{N}. A shared slot may be a slot in which scheduler 206 is capable of performing a selection, but does not perform the selection because each of queues 204₀-204_{N} does not contain any cells (or is ineligible to transmit cells during that slot for other reasons (e.g., traffic shaping). That is, a shared slot may be a null shared slot.

In accordance with some embodiments, selective delay logic 200 may be configured to delay the provision of state indicator(s) in response to determining that the number of null shared slots exceeds a predetermined threshold in lieu of or in addition to determining that a percentage of null shared slots in the plurality of slots exceeds a predetermined threshold.

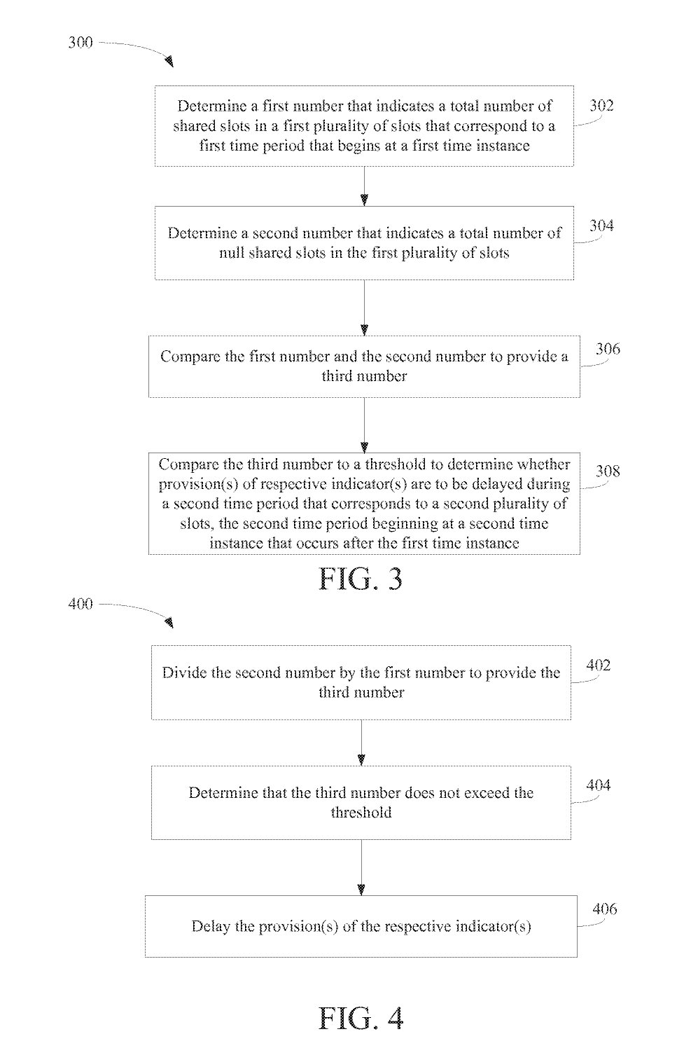

Accordingly, in embodiments, switching device 100 may operate in various ways to mitigate bandwidth degradation, which is caused, at least in part, by a latency associated with the queue(s) included in buffer and scheduling logic 104 and/or memory and traffic management logic 108 transitioning from an active state to an empty state. For example, FIG. 3 depicts a flowchart 300 providing example steps for mitigating bandwidth degradation in accordance with an embodiment. Switching device 100 of FIG. 1 and selective delay logic 200 and queue and scheduling logic 202 of FIG. 2 may each perform the steps of flowchart 300. Other structural and operational embodiments will be apparent to persons skilled in the relevant art(s) based on the discussion regarding flowchart 300. Flowchart 300 is described as follows.

Flowchart 300 begins with step 302. In step 302, a first number that indicates a total number of shared slots in a first plurality of slots is determined. The first plurality of slots corresponds to a first time period that begins at a first time instance. An example of a shared slot is a slot that is provided to ports that are not guaranteed to achieve maximum throughput. Each slot may be a single clock cycle in which data may be received by switching device 100 (or a component therein).

Switching device 100 may enter into an oversubscribed state when the supported I/O bandwidth (i.e., the sum of the peak operating rates for all the ports (e.g., ingress ports 102₀-102_{N} and/or egress ports 112₀-112_{N})) exceeds the throughput provided by switching device 100 for the worst case packet size (i.e., a packet size among a plurality of packet sizes at which the bandwidth of switching device 100 is lowest with respect to others of the plurality of packet sizes). An oversubscribed state may occur, for example, when a majority of the ports receive relatively smaller packet sizes at a high data rate.

In an example implementation, selective delay logic 200 determines the first number. For example, selective delay logic 200 may monitor scheduler 206 to determine each slot in the first plurality of slots in which scheduler 206 performs a selection or is capable of performing a selection of a queue from queues 204₀-204_{N}.

At step 304, a second number that indicates a total number of null shared slots in the first plurality of slots is determined. An example of a null shared slot is slot during which no queue is selected (independent of whether or not switching device 100 is in an oversubscribed state). During a null shared slot, scheduler 206 may be capable of selecting at least one of queue 204₀-204_{N}, but does not because each of queues 204₀-204_{N} does not contain any cells (or is ineligible to transmit cells during that slot for other reasons (e.g., traffic shaping). In accordance with an embodiment, cells are portions of packets received from one or more ingress ports 102₀-102_{N} that are assembled into one or more segments.

In an example implementation, selective delay logic 200 determines the second number. For example, selective delay logic 200 may monitor scheduler 206 to determine each slot in the first plurality of slots in which scheduler 206 is capable of performing a selection but does not because no cells are available in queues 204₀-204_{N}.

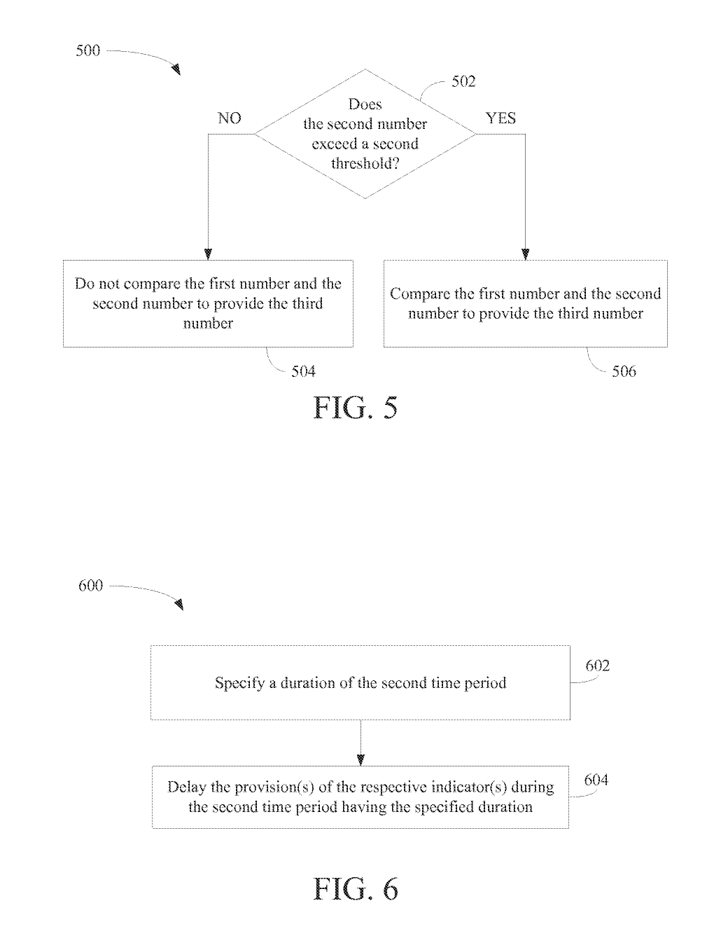

At step 306, the first number and the second number are compared to provide a third number. In an example implementation, selective delay logic 200 compares the first number to the second number to provide the third number. In accordance with an embodiment, the third number is indicative of a proportion of null shared slots in the first plurality of slots to the total shared slots in the first plurality of slots. One example technique for determining a proportion of null shared slots to the total shared slots is described below with reference to step 402 of FIG. 4.

At step 308, the third number is compared to a threshold to determine whether one or more provisions of one or more respective indicators are to be delayed during a second time period that corresponds to a second plurality of slots. The second time period begins at a second time instance that occurs after the first time instance.

If the third number does not exceed the threshold, then selective delay logic 200 may determine that the traffic load exceeds its processing ability. In such a case, selective delay logic 200 may determine that one or more provisions of one or more respective indicators are to be delayed. If the third number does exceed the threshold, then selective delay logic 200 may determine that the throughput is maximized.

In an example implementation, selective delay logic 200 compares the third number to the threshold.

In an example embodiment, the threshold is predetermined, meaning that the threshold is determined prior to determining the first number, determining the second number, and/or comparing the first number and the second number. For example, the threshold may be exposed as a configurable parameter, thereby allowing the value of this parameter to be selected to achieve desired performance.

The delayed provision of the state indicator(s) may occur after queue(s) 204₀-204_{N} transition from an active state to an empty state and have received and stored cell(s). In an example embodiment, the provision of a state indicator, which indicates that a particular queue is in an active state, to scheduler 206 is delayed.

FIGS. 4 and 5 depict flowcharts 400 and 500 providing example steps for delaying provision(s) of state indicator(s) in accordance with embodiments. Switching device 100 of FIG. 1 and selective delay logic 200 and queue and scheduling logic 202 of FIG. 2 may each perform the steps of flowcharts 400 and 500. Other structural and operational embodiments will be apparent to persons skilled in the relevant art(s) based on the discussion regarding flowcharts 400 and 500. Flowcharts 400 and 500 are described as follows.

Flowchart 400 begins with step 402. In step 402, the second number is divided by the first number to provide the third number. In accordance with an embodiment, the third number is indicative of a proportion of null shared slots in the first plurality of slots to the total shared slots in the first plurality of slots.

In an example implementation, selective delay logic 200 divides the second number by the first number to provide the third number.

In step 404, a determination is made that the third number does not exceed (e.g., is less than or equal to) the threshold. In an example implementation, selective delay logic 200 determines that the third number does not exceed the threshold. In such a case, selective delay logic 200 may determine that the traffic load exceeds its processing ability.

In step 406, the one or more provisions of the one or more respective indicators are delayed in response to determining that the third number does not exceed the threshold. The delayed provision of the state indicator(s) may occur after queue(s) 204₀-204_{N} transition from an active state to an empty state and have received and stored cell(s). In an example embodiment, the provision of a state indicator, which indicates that a particular queue is in an active state, to scheduler 206 is delayed.

In an example implementation, selective delay logic 200 delays the provision(s) of the respective indicator(s) in response to determining that the third number does not exceed the threshold.

It is noted that in response to a determination that the third number does exceed (e.g., is greater than) the threshold, selective delay logic 200 may determine that throughput is maximized, and therefore, does not delay the provision(s) of the respective indicator(s).

Flowchart 500 begins with step 502. In step 502, it is determined whether the second number exceeds a second threshold. If it is determined that the second number does not exceed the second threshold, then flow continues to step 504. Otherwise, flow continues to step 506.

In accordance with an embodiment, the second number indicates a total number of null shared slots in the first plurality of slots is determined. An example of a null shared slot is slot during which no queue is selected (independent of whether or not switching device 100 is in an oversubscribed state). During a null shared slot, scheduler 206 may be capable of selecting at least one of queue 204₀-204_{N}, but does not because each of queues 204₀-204_{N} does not contain any cells (or is ineligible to transmit cells during that slot for other reasons (e.g., traffic shaping).

In an example implementation, selective delay logic 200 determines whether the second number exceeds the second threshold. For example, selective delay logic 200 may monitor scheduler 206 to determine each slot in the plurality of slots in which scheduler 206 is capable of performing a selection but does not because no cells are available in queues 204₀-204_{N}.

In step 504, the first number and the second number are not compared to provide the third number based on the second number not exceeding the second threshold. In such a case, selective delay logic 200 may determine that the throughput is maximized, and therefore, does not perform the comparison between the first number and second number to determine whether to delay the provision(s) of the state indicator(s).

In step 506, the first number and the second number are compared to provide the third number based on the second number exceeding the second threshold. In accordance with an embodiment, the third number is indicative of a proportion of null shared slots in the first plurality of slots to the total shared slots in the first plurality of slots.

In an example implementation, selective delay logic 200 may compare the first number and the second number based on the second number exceeding the second threshold. In such a case, selective delay logic 200 may determine that the traffic load exceeds its processing ability, and therefore, performs the comparison between the first number and second number to determine whether or not to delay the provision(s) of the state indicator(s).

In accordance with an embodiment, the provision(s) of state indicator(s) are delayed for a specified duration of a period of time (e.g., a predetermined period of time and/or a predetermined number of slots). For example, each time a queue receives and stores cell(s) after transitioning from an active state to an empty state during the period of time, the provision of the state indicator indicating that the queue is in the active state is delayed. The duration of the specified period of time may be initiated in response to determining that the traffic load exceeds its processing ability (e.g., when the ratio of null shared slots to the total shared slots exceeds a threshold). Upon the duration of the period of time completing, the provision(s) of the state indicator(s) are no longer delayed each time a queue receives and stores cell(s) after transitioning from an active state to an empty state. The delaying of the provision(s) of the state indicator(s) may resume upon a determination that the traffic load is again exceeding its processing ability. Accordingly, selective delay logic 200 may be configured to continuously monitor scheduler 206 to determine whether the ratio of null shared slots to the total shared slots exceeds a threshold.

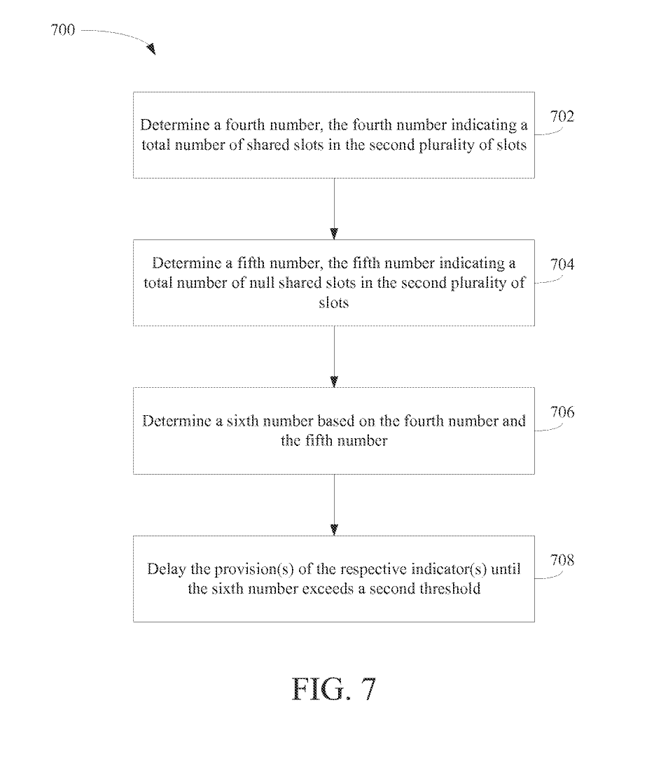

FIGS. 6 and 7 depict flowcharts 600 and 700 providing example steps for discontinuing the delaying of provision(s) of state indicator(s) in accordance with embodiments. Switching device 100 of FIG. 1 and selective delay logic 200 and queue and scheduling logic 202 of FIG. 2 may each perform the steps of flowcharts 600 and 700. Other structural and operational embodiments will be apparent to persons skilled in the relevant art(s) based on the discussion regarding flowcharts 600 and 700. Flowcharts 600 and 700 are described as follows.

Flowchart 600 begins with step 602. In step 602, a duration of the second time period is specified. In an example implementation, selective delay logic 200 specifies the duration of the second time period. The specified duration of the second time period may be initiated in response to determining that the traffic load exceeds its processing ability.

For example, selective delay logic 200 may be configured to determine the percentage of slots in which no queue was selected for scheduling over a predetermined sampling period (e.g., an N number of slots, where N is any positive integer). If the percentage of null shared slots does not exceed (e.g., is less than or equal to) a threshold (e.g., a predetermined threshold), then selective delay logic 200 may determine that the traffic load exceeds its processing ability.

In an example embodiment, the specified duration of the second time period is predetermined, meaning that the duration of the second time period is determined prior to determining whether the provision(s) of the state indicator(s) are to be delayed. For example, the duration of the second time period may be exposed as a configurable parameter, thereby allowing the value of this parameter to be selected to achieve desired performance.

In step 604, the one or more provisions of the one or more respective indicators are delayed during the second time period having the specified duration. In an example implementation, selective delay logic 200 delays the provision(s) of the respective indicator(s). The delaying of the provision(s) of the respective indicator(s) may discontinued when the duration of the second time period completes.

The delayed provision of the state indicator(s) may occur after queue(s) 204₀-204_{N} transition from an active state to an empty state and have received and stored cell(s). In an example embodiment, the provision of a state indicator, which indicates that a particular queue is in an active state, to scheduler 206 is delayed.

In another example embodiment, the provision(s) of the state indicator(s) are delayed until the ratio of null shared slots to the total shared slots exceeds the threshold. In accordance with this embodiment, selective delay logic 200 continues to determine the ratio of null shared slots to the total shared slots after the delaying of the provision(s) of state indicator(s) has begun. In response to determining that the ratio exceeds the threshold, the provision(s) of the state indicator(s) are no longer delayed.

Flowchart 700 begins with step 702. In step 702, a fourth number is determined. The fourth number indicates a total number of shared slots in the second plurality of slots.

In an example implementation, selective delay logic 200 determines the fourth number.

In step 704, a fifth number is determined. The fifth number indicates a total number of null shared slots (e.g., slots in which no queue is selected (independent of whether or not switching device 100 is in an oversubscribed state)) in the second plurality of slots. During a null shared slot, scheduler 206 may be capable of selecting at least one of queue 204₀-204_{N}, but does not because each of queues 204₀-204_{N} does not contain any cells (or is ineligible to transmit cells during that slot for other reasons (e.g., traffic shaping).

In an example implementation, selective delay logic 200 determines the fifth number.

In step 706, a sixth number is determined that is based on the fourth number and the fifth number. In accordance with an embodiment, the sixth number is indicative of a proportion of null shared slots in the second plurality of slots to the total shared slots in the second plurality of slots.

In an example implementation, selective delay logic 200 determines the sixth number. In accordance with an embodiment, selective delay logic 200 determines the sixth number by dividing the fifth number by the fourth number.

In step 708, the one or more provisions of the respective one or more indicators are delayed until the sixth number exceeds a second threshold. The delayed provision of the state indicator(s) may occur after queue(s) 204₀-204_{N} transition from an active state to an empty state and have received and stored cell(s). In an example embodiment, the provision of a state indicator, which indicates that a particular queue is in an active state, to scheduler 206 is delayed.

In an example implementation, selective delay logic 200 delays the provision(s) of the respective indicator(s) until the sixth number exceeds the second threshold. In accordance with an embodiment, the second threshold is the same as the first threshold. In accordance with another embodiment, the second threshold is different from the first threshold.

Upon the sixth number exceeding the second threshold, the provision of the state indicator(s) is no longer delayed.

In yet another example embodiment, the delaying of the provision(s) of state indicator(s) is based on an amount of incoming data received by switching device 100 (e.g., received by queues 204₀-204_{N} of switching device 100) exceeding a threshold. For example, if a determination is made that the amount of incoming data received by queues 204₀-204_{N} does not exceed the threshold, then the duration of the second time period is ended, and the delaying of the provision(s) of state indicator(s) is discontinued. In such a case, it may be determined that the amount of active-to-empty transitions for each of queues 204₀-204_{N} is relatively low due to the lack of traffic received by switching device 100. If a determination is made that the amount of incoming data received by queues 204₀-204_{N} exceeds the threshold, then the delaying of the provision(s) of state indicator(s) is continued.

### III. Example Computer System Implementation

Switching device 100, buffer and scheduling logic 104, ingress packet processor 106, memory and traffic management logic 108, egress packet processor 110, selective delay logic 114, selecting delay logic 200, queue and scheduling logic 202, queues 204₀-204_{N}, and scheduler 206 may be implemented in hardware, or any combination of hardware with software and/or firmware. For example, switching device 100, buffer and scheduling logic 104, ingress packet processor 106, memory and traffic management logic 108, egress packet processor 110, selective delay logic 114, selecting delay logic 200, queue and scheduling logic 202, queues 204₀-204_{N}, and scheduler 206 may be implemented as computer program code configured to be executed in one or more processors. In another example, switching device 100, buffer and scheduling logic 104, ingress packet processor 106, memory and traffic management logic 108, egress packet processor 110, selective delay logic 114, selecting delay logic 200, queue and scheduling logic 202, queues 204₀-204_{N}, and scheduler 206 may be implemented as hardware (e.g., hardware logic/electrical circuitry), or any combination of hardware with software (computer program code configured to be executed in one or more processors or processing devices) and/or firmware.

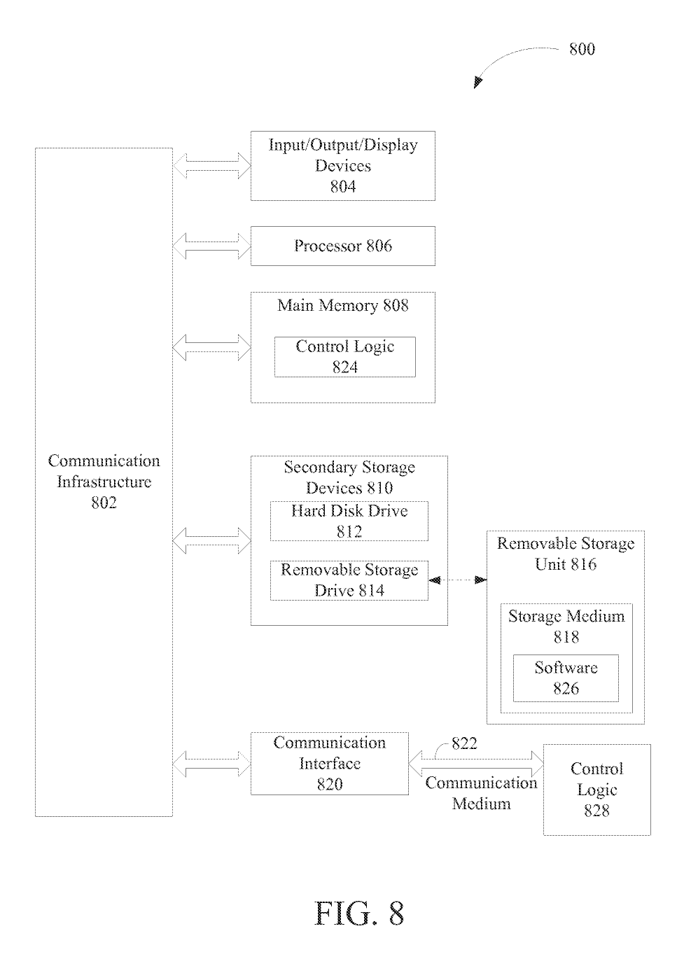

The embodiments described herein, including systems, methods/processes, and/or apparatuses, may be implemented using well known servers/computers, such as computer 800 shown in FIG. 8. For example, elements of switching device 100, including any of buffer and scheduling logic 104, ingress packet processor 106, memory and traffic management logic 108, egress packet processor 110, and selective delay logic 114 depicted in FIG. 1 and elements thereof; selecting delay logic 200 and elements of queue and scheduling logic 202, including queues 204₀-204_{N} and scheduler 206 depicted in FIG. 2 and elements thereof; each of the steps of flowchart 300 depicted in FIG. 3; each of the steps of flowchart 400 depicted in FIG. 4; each of the steps of flowchart 500 depicted in FIG. 5; each of the steps of flowchart 600 depicted in FIG. 6; and each of the steps of flowchart 700 depicted in FIG. 7 can each be implemented using one or more computers 800.

Computer 800 can be any commercially available and well known computer capable of performing the functions described herein, such as computers available from International Business Machines, Apple, Sun, HP, Dell, Cray, etc. Computer 800 may be any type of computer, including a desktop computer, a server, etc.

As shown in FIG. 8, computer 800 includes one or more processors (also called central processing units, or CPUs), such as a processor 806. Processor 806 may include switching device 100, buffer and scheduling logic 104, ingress packet processor 106, memory and traffic management logic 108, egress packet processor 110, and/or selective delay logic 114 of FIG. 1; selecting delay logic 200, queue and scheduling logic 202, queues 204₀-204_{N}, and/or scheduler 206 of FIG. 2; or any portion or combination thereof, for example, though the scope of the embodiments is not limited in this respect. Processor 806 is connected to a communication infrastructure 802, such as a communication bus. In some embodiments, processor 806 can simultaneously operate multiple computing threads.

Computer 800 also includes a primary or main memory 808, such as random access memory (RAM). Main memory 808 has stored therein control logic 824 (computer software), and data.

Computer 800 also includes one or more secondary storage devices 810. Secondary storage devices 810 include, for example, a hard disk drive 812 and/or a removable storage device or drive 814, as well as other types of storage devices, such as memory cards and memory sticks. For instance, computer 800 may include an industry standard interface, such a universal serial bus (USB) interface for interfacing with devices such as a memory stick. Removable storage drive 814 represents a floppy disk drive, a magnetic tape drive, a compact disk drive, an optical storage device, tape backup, etc.

Removable storage drive 814 interacts with a removable storage unit 816. Removable storage unit 816 includes a computer useable or readable storage medium 818 having stored therein computer software 826 (control logic) and/or data. Removable storage unit 816 represents a floppy disk, magnetic tape, compact disc (CD), digital versatile disc (DVD), Blu-ray™ disc, optical storage disk, memory stick, memory card, or any other computer data storage device. Removable storage drive 814 reads from and/or writes to removable storage unit 816 in a well-known manner.

Computer 800 also includes input/output/display devices 804, such as monitors, keyboards, pointing devices, etc.

Computer 800 further includes a communication or network interface 820. Communication interface 820 enables computer 800 to communicate with remote devices. For example, communication interface 820 allows computer 800 to communicate over communication networks or mediums 822 (representing a form of a computer useable or readable medium), such as local area networks (LANs), wide area networks (WANs), the Internet, etc. Network interface 820 may interface with remote sites or networks via wired or wireless connections. Examples of communication interface 822 include but are not limited to a modem, a network interface card (e.g., an Ethernet card), a communication port, a Personal Computer Memory Card International Association (PCMCIA) card, etc.

Control logic 828 may be transmitted to and from computer 800 via the communication medium 822.

Any apparatus or manufacture comprising a computer useable or readable medium having control logic (software) stored therein is referred to herein as a computer program product or program storage device. This includes, but is not limited to, computer 800, main memory 808, secondary storage devices 810, and removable storage unit 816. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for implementing the elements of switching device 100, including any of buffer and scheduling logic 104, ingress packet processor 106, memory and traffic management logic 108, egress packet processor 110, selective delay logic 114, selecting delay logic 200 and/or elements of queue and scheduling logic 202, including queues 204₀-204_{N} and/or scheduler 206, flowcharts 300, 400, 500, 600, and 700, and/or further embodiments described herein. Embodiments of the invention are directed to computer program products comprising such logic (e.g., in the form of program code, instructions, or software) stored on any computer useable medium. Such program code, when executed in one or more processors, causes a device to operate as described herein.

Note that such computer-readable storage media are distinguished from and non-overlapping with communication media. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

### IV. Further Example Embodiments

Communication systems may include various types of devices that include transceivers to communicate data between a variety of devices. Embodiments described herein may be included in transceivers of such devices. For instance, embodiments may be included in mobile devices (laptop computers, handheld devices such as mobile phones (e.g., cellular and smart phones), handheld computers, handheld music players, and further types of mobile devices), desktop computers and servers, computer networks, and telecommunication networks.

Embodiments can be incorporated into various types of communication systems, such as intra-computer data transmission structures (e.g., Peripheral Component Interconnect (PCI) Express bus), telecommunication networks, traditional and wireless local area networks (LANs and WLANs), wired and wireless point-to-point connections, optical data transmission systems (e.g., short haul, long haul, etc.), high-speed data transmission systems, coherent optical systems and/or other types of communication systems using transceivers.

### V. CONCLUSION

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A method comprising:
determining a first number that indicates a total number of shared slots in a first plurality of slots that correspond to a first time period that begins at a first time instance;
determining a second number that indicates a total number of null shared slots in the first plurality of slots;
comparing the first number and the second number to provide a third number; and
comparing the third number to a threshold to determine whether one or more provisions of one or more respective indicators are to be delayed during a second time period that corresponds to a second plurality of slots, the second time period beginning at a second time instance that occurs after the first time instance, each of the one or more indicators specifying that data is available to be scheduled for processing.

2. The method of claim 1, wherein comparing the first number and the second number comprises:
dividing the second number by the first number to provide the third number;
wherein comparing the third number to the threshold comprises:
determining that the third number does not exceed the threshold; and
wherein the method further comprises:
delaying the one or more provisions of the one or more respective indicators in response to determining that the third number does not exceed the threshold.

3. The method of claim 2, further comprising:
specifying a duration of the second time period;
wherein delaying the one or more provisions of the one or more respective indicators comprises:
delaying the one or more provisions of the one or more respective indicators during the second time period having the specified duration.

4. The method of claim 2, further comprising:
determining a fourth number and a fifth number, the fourth number indicating a total number of shared slots in the second plurality of slots, the fifth number indicating a total number of null shared slots in the second plurality of slots;
determining a sixth number based on the fourth number and the fifth number; and
delaying the one or more provisions of the one or more respective indicators until the sixth number exceeds a second threshold, a duration of the second time period completing upon the sixth number exceeding the second threshold.

5. The method of claim 1, further comprising:
determining whether the second number exceeds a second threshold;
wherein comparing the first number and the second number comprises:
comparing the first number and the second number to provide the third number based on the second number exceeding the second threshold.

6. A switching device, comprising:
a plurality of queues;
a scheduler coupled to the plurality of queues; and
selective delay logic coupled to the plurality of queues and the scheduler, the selective delay logic configured to:
determine a first number of slots that are included in a first plurality of slots, which correspond to a first time period that begins at a first time instance;
determine a second number of slots that are included in the first plurality of slots for which the scheduler does not perform a selection of at least one of the plurality of ports;
compare the first number and the second number to provide a third number, and
compare the third number to a threshold to determine whether one or more provisions of one or more respective indicators provided by at least one queue of the plurality of queues for receipt by the scheduler are to be delayed during a second time period to which a second plurality of slots corresponds, the second time period beginning at a second time instance that occurs after the first time instance, each of the one or more indicators specifying that data stored in one or more of the plurality of queues is available to be provided to the scheduler.

7. The switching device of claim 6, wherein the selective delay logic is configured to:
divide the second number by the first number to provide the third number;
determine whether the third number exceeds the threshold; and
delay the one or more provisions of the one or more respective indicators in response to a determination that the third number does not exceed the threshold.

8. The switching device of claim 7, wherein the selective delay logic is further configured to:
specify a duration of the second time period; and
delay the one or more provisions of the one or more respective indicators during the second time period having the specified duration.

9. The switching device of claim 7, wherein the selective delay logic is further configured to:
determine a fourth number and a fifth number, the fourth number indicating number of slots in the second plurality of slots, the fifth number indicating a number of slots in the second plurality of slots for which the scheduler does not perform a selection of at least one of the plurality of ports;
determine a sixth number based on the fourth number and the fifth number; and
delay the one or more provisions of the one or more respective indicators until the sixth number exceeds a second threshold, a duration of the second time period completing upon the sixth number exceeding the second threshold.

10. The switching device of claim 7, wherein the selective delay logic is configured to:
determine whether an amount of incoming data received by the plurality of queues exceeds a second threshold;
delay the one or more provisions of the one or more respective indicators further in response to a determination that the amount of incoming data does not exceed the second threshold; and
end the second time period in response to a determination that the amount of incoming data exceeds the second threshold.

11. The switching device of claim 7, wherein the selective delay logic is configured to:
determine whether the second number exceeds a second threshold; and
compare the first number and the second number to provide the third number in response to a determination that the second number exceeds the second threshold.

12. The switching device of claim 6, wherein the at least one queue provides the one or more indicators in response to the at least one queue transitioning from an empty state to an active state,
wherein the active state indicates that the at least one queue of the plurality of queues contains data, and
wherein the empty state indicates that the at least one queue of the plurality of queues does not contain data.

13. The switching device of claim 6, wherein a time period for which the one or more indicators are delayed is based on a data rate at which at least one port to which one or more queues of the plurality of queues are coupled operates.

14. A computer readable storage medium having computer program instructions embodied in said computer readable storage medium for enabling a processor to mitigate bandwidth degradation for a switching device, the computer program instructions including instructions executable to perform operations comprising:
determining a first number that indicates a total number of shared slots in a first plurality of slots that correspond to a first time period that begins at a first time instance;
determining a second number that indicates a total number of null shared slots in the first plurality of slots;
comparing the first number and the second number to provide a third number; and
comparing the third number to a threshold to determine whether one or more provisions of one or more respective indicators are to be delayed during a second time period that corresponds to a second plurality of slots, the second time period beginning at a second time instance that occurs after the first time instance, each of the one or more indicators specifying that data is available to be scheduled for processing.

15. The computer readable storage medium of claim 14, wherein comparing the first number and the second number comprises:
dividing the second number by the first number to provide the third number;
wherein comparing the third number to the threshold comprises:
determining that the third number does not exceed the threshold; and
wherein the method further comprises:
delaying the one or more provisions of the one or more respective indicators in response to determining that the third number does not exceed the threshold.

16. The computer readable storage medium of claim 15, the operations further comprising:
specifying a duration of the second time period;
wherein delaying the one or more provisions of the one or more respective indicators comprises:
delaying the one or more provisions of the one or more respective indicators during the second time period having the specified duration.

17. The computer readable storage medium of claim 15, the operations further comprising:
determining a fourth number and a fifth number, the fourth number indicating a total number of shared slots in the second plurality of slots, the fifth number indicating a total number of null shared slots in the second plurality of slots;
determining a sixth number based on the fourth number and the fifth number; and
delaying the one or more provisions of the one or more respective indicators until the sixth number exceeds a second threshold, a duration of the second time period completing upon the sixth number exceeding the second threshold.

18. The computer readable storage medium of claim 15, the operations comprising:
determining whether an amount of incoming data received by the switching device exceeds a second threshold; and
delaying the one or more provisions of the one or more respective indicators further in response to determining that the amount of incoming data exceeds the second threshold; and
ending the second time period in response to determining that the amount of incoming data does not exceed the second threshold.

19. The computer readable storage medium of claim 15, wherein a time period for which the one or more indicators are delayed is based on a data rate at which at least one port included in the switching device operates.

20. The computer readable storage medium of claim 15, the operations further comprising:
determining whether the second number exceeds a second threshold;
wherein comparing the first number and the second number comprises:
comparing the first number and the second number to provide the third number based on the second number exceeding the second threshold.
